(19) United States
(12) Patent Application Publication
(10) Pub. No.: US 2011/0001632 A1
(43) Pub. Date: Jan. 6, 2011

(54) Method and System for Changing an Input Source for an Electronic Device

(76) Inventor: Andrew Gordon Hohorst, Frederick, MD (US)

Correspondence Address: Stamoulis & Weinblatt LLC, Two Fox Point Centre, 6 Denny Road, Suite 307, Wilmington, DE, 19809, US

(21) Appl. No.: 12/495,903

(22) Filed: Jul. 1, 2009

(51) Int. Cl. G08C 19/00

(52) U.S. Cl. 340/825.69

(57) ABSTRACT

A system and method for changing an input source for an electronic device capable of receiving a signal from a plurality of external devices are described. In some implementations, the system and method determines if an external electronic device is active. If an external electronic device is active, then a determination is made as to whether an input source for the electronic device is set to the active external electronic device. The input source for the electronic device may be set to the active external electronic device if a change to the input source is required. In some implementations, the electronic device is powered on or woken, if required, after determining that an external electronic device is active.

### TECHNICAL FIELD

This application relates in general to electronic devices, and, in particular, to monitors, stereos, receivers, home theaters, and sound systems.

### BACKGROUND

Many people have home theaters or televisions connected to multiple input sources. Such input sources may include a cable box, a satellite receiver, a digital versatile disc (DVD) player, a compact disc (CD) player, a digital video recorder (DVR), or a gaming console, such as Microsoft Xbox 360®, Sony PlayStation®, or Nintendo Wii®. When a user turns on a television or home theater, the input source for the television or home theater typically is set to the last input source selected before powering off the television or home theater.

If the user wishes to watch or hear something from an input source different from what was selected when the television or receiver first was powered on, the input source generally has to be changed. For example, if the last input source set on a television or was a gaming console and the television was turned off, when the user turns on the television again, the television generally already has the gaming console input source activated. However, if the user wishes to watch a DVD, the user generally has to change the input source from the gaming console input source to the DVD input source.

Remote controls, such as the Harmony® 880 Advanced Universal Remote Control, generally, may be programmed to change the input source when a user selects a specific activity, e.g., watch television, watch DVD, etc., so that a user does not have to manually press each button on the remote control to change the input source; such programmed commands may be called “macros.” In either situation, the remote control or the user typically changes the input source by making selections so that the input source is changed.

### SUMMARY

This application describes a system and method for changing an input source for an electronic device.

In accordance with one implementation, a system for changing an input source for an electronic device capable of receiving a signal from a plurality of external electronic devices comprises an electronic system communicatively coupled to the electronic device. The electronic system may be adapted to determine if an external electronic device is active. If an external electronic device is active, the electronic system may determine if an input source for the electronic device is set to the active external electronic device and set the input source for the electronic device to the active external electronic device if a change to the input source is required.

In accordance with another implementation, a method for changing an input source for an electronic device capable of receiving a signal from a plurality of external electronic devices comprises determining if an external electronic device is active, if an external electronic device is active, determining if an input source for the electronic device is set to the active external electronic device, and setting the input source for the electronic device to the active external electronic device if a change to the input source is required.

In accordance with yet another implementation, a system for an electronic device capable of receiving a signal from a plurality of external electronic devices comprises an electronic system communicatively coupled to the electronic device. The electronic system may determine if an external electronic device is active, and wake or power on the electronic device, if required, after determining that an external electronic device is active. If an external electronic device is active, the electronic system may determine if an input source for the electronic device is set to the active external electronic device and set the input source for the electronic device to the active external electronic device if a change to the input source is required.

The details of one or more implementations are set forth in the accompanying drawings and the description below. Other features, aspects, and advantages will become apparent from the description, the drawings, and the claims.

It is to be understood that the foregoing general description and the detailed description are exemplary, but not restrictive of the towel rack device or the method for making the towel rack device.

### DESCRIPTION OF DRAWINGS

In the drawings, which are discussed below, one or more implementations are illustrated. It is understood that the electronic device is not limited to the implementations depicted in the drawings herein, but rather it is defined by the claims appended hereto and equivalent structures.

FIG. 1 is a block diagram of an exemplary implementation of an electronic device connected to external electronic devices.

FIG. 2 is a block diagram of an exemplary implementation of an electronic system electrically connected to a power source and in communication with external electronic devices.

FIG. 3 is a flowchart of an exemplary implementation of an electronic system for changing an input source for an electronic device.

FIG. 4 is a flowchart of another exemplary implementation of an electronic system for changing an input source for an electronic device.

FIG. 5 is a flowchart of another exemplary implementation of an electronic system for changing an input source for an electronic device.

FIG. 6 is a block diagram of an exemplary implementation of an electronic system.

Like reference symbols in the various drawings indicate like elements.

### DETAILED DESCRIPTION

While the specification concludes with claims particularly pointing out and distinctly claiming subject matter, the system and method for changing the input source for an electronic device will now be further described by reference to the following detailed description of exemplary implementations taken in conjunction with the above-described accompanying drawings. The following description is presented to enable any person skilled in the art to make and use the system and method for changing the input source for an electronic device. Descriptions of specific implementations and applications are provided only as non-limiting examples and various modifications will be readily apparent to those skilled in the art. The general principles defined herein may be applied to other implementations and applications without departing from the spirit and scope of the system and method described. Thus, the system and method for changing the input source for an electronic device is to be accorded the widest scope encompassing numerous alternatives, modifications, and equivalents consistent with the principles and features disclosed herein. For purpose of clarity, details relating to technical material that is known in the technical fields related to the towel rack device have not been described in detail so as not to unnecessarily obscure the present application.

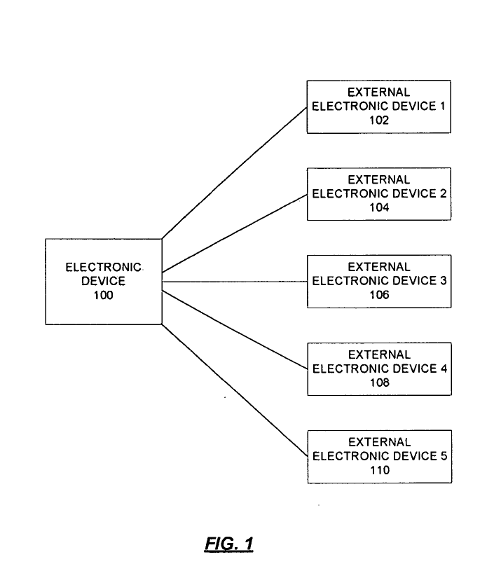

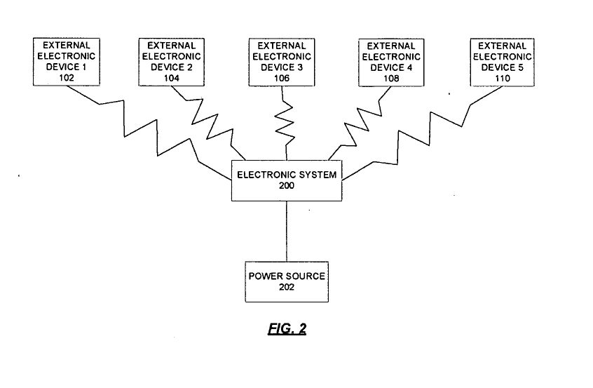

As shown in FIGS. 1 and 2, an electronic device 100 is connected to five external electronic devices, 102, 104, 106, 108, 110. The connection may be a direct or indirect connection. The electronic device 100 may be a monitor, a stereo, a receiver, a sound system, a home theater system, or a similar device. The external electronic devices 102, 104, 106, 108, 110 may be cable boxes, satellite receivers, DVD players, DVRs, gaming consoles, computers, and the like. The electronic device 100 is capable of receiving a signal from the external electronic devices 102, 104, 106, 108, 110. The external electronic devices 102, 104, 106, 108, 110 may be electrically connected to electronic system 200. The electronic system 200 is electrically connected to a power source 202.

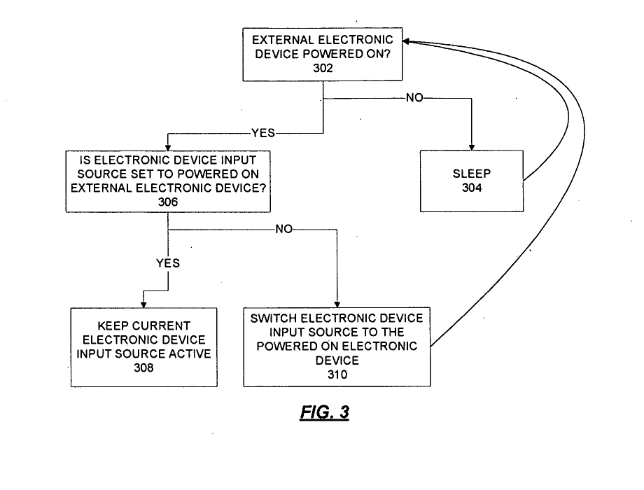

FIG. 3 shows an implementation of electronic system 200. The electronic system 200 may be contained within the electronic device 100. The power source 202 may be a power source already used by the electronic device 100 or it may be independent thereof. A non-limiting example of the power source 202 may be direct power.

Input into the electronic system 200 takes place through an external electronic device 102, 104, 106, 108, 110. When an external electronic device is powered on or is active, a signal is transmitted from the external electronic device to the electronic system 200. Similarly, when an external electronic device is powered off or is inactive, no signal is transmitted from the external electronic device to the electronic system 200.

The electronic system 200 monitors the electronic signals from the external electronic devices 102, 104, 106, 108, 110. As shown in the exemplary flow chart of FIG. 3, the electronic system 200 determines whether an external electronic device is powered on 302. If the external electronic device is not powered on, no signal is transmitted from the external electronic device to the electronic system 200, and the electronic system 200 instructs the electronic device 100 to enter a “sleep” or “hibernate” mode 304 and returns to block 302. Sleep or hibernate modes are well-known within the art and will not be further explained in this application. If the external electronic device has been powered on, the electronic system 200 receives a signal from the external electronic device and checks the input source setting on the electronic device 100 to determine whether the powered on external electronic device is the current input source 306. If the input source is set to the powered on external electronic device, then the input source for the external device 100 is not changed 308. However, if the input source for the electronic device 100 is not set to the powered on external electronic device, then the electronic system 200 sets the input source on the electronic device 100 to the powered on external electronic device 310.

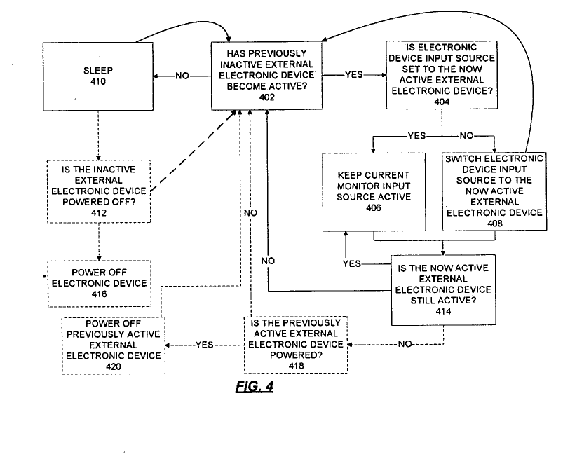

In some implementations, as shown in the exemplary flow chart of FIG. 4, the electronic system 200 checks whether a previously inactive external electronic device, i.e., an external electronic device that has not been powered on or that is powered on but not in use, becomes active 402. If the inactive external electronic device becomes active, the electronic system 200 checks whether the input source for the electronic device 100 is set to the now active external electronic device 404. If the input source for the electronic device 100 is set to the now active external electronic device, then the electronic device's input source is not changed 406. If, on the other hand, the electronic device's input source is not set to the now active external electronic device, then the electronic system 200 sets the electronic device's input source to the now active external electronic device 408. After block 406 or 408, the electronic system 200 determines whether the now active external electronic device remains active 414. If the now active external electronic device does remain active, then the electronic system 200 returns to block 406. If the now active external electronic device does not remain active, then the electronic system 200 returns to block 402.

In some implementations, as shown by the dashed lines, before returning to block 402, the electronic system 200 checks whether the previously active external device is powered on 418 and if it is, then the electronic system 200 powers off the previously active external electronic device 420, but if the previously active external electronic device does not have power, then the electronic system 200 returns to block 402.

Referring back to block 402, if the previously inactive external electronic device does not become active, then the electronic system 200 has the electronic device enter a sleep or hibernation mode 410 and then returns to block 402.

In some implementations, shown by dashed lines, the electronic system 200 checks whether the previously inactive external device is powered off 412. If it is powered off, then the electronic system 200 returns to block 402. If the previously inactive external electronic device is already powered on, the electronic system 200 powers off the electronic device 416.

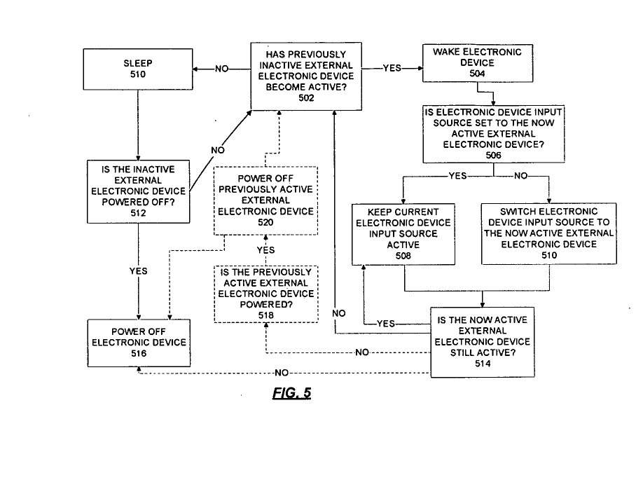

Another implementation of electronic system 200 is shown in FIG. 5. The electronic system 200 determines whether an external electronic device becomes active 502. If the external electronic device does not become active, no signal is transmitted from the external electronic device to the electronic system 200, and the electronic system 200 instructs the electronic device 100 to enter or stay in a “sleep” or “hibernate” mode 510.

If the external electronic device has been powered on, the electronic system 200 wakes the electronic device 100 from a sleep or hibernate mode 504. After block 504, the electronic system 200 checks whether the input source on the electronic device 100 is set to the now active external electronic device 506. If the current input source already is set on the active external electronic device, then the input source on the electronic device 100 is not changed 508. However, if the input source on the electronic device 100 is not already set to the active external electronic device, then the electronic system 200 switches the input source on the electronic device 100 to the now active external electronic device 510.

After block 508 or 510, the electronic system 200 determines whether the now active external electronic device remains active 514. If the now active external electronic device does remain active, then the electronic system 200 returns to block 508. If the now active external electronic device does not remain active, then the electronic system 200 returns to block 502.

In some implementations, as shown by the dashed lines, before returning to block 502, the electronic system 200 checks whether the previously active external device is powered 518 and if it is, then the electronic system 200 powers off the previously active external electronic device 520. In some implementations, if the previously active external electronic device does not have power, then the electronic system 200 returns to block 502. In some implementations, if the previously active external electronic device does not have power, then the electronic system 200 powers off the electronic device 516.

In some implementations, after block 514, if the external electronic device is not active, the electronic system 200 powers off the electronic device 516.

Referring to block 502, if the previously inactive external electronic device does not become active, then the electronic system 200 activates a sleep or hibernation mode 510 for the electronic device 100. The electronic system 200 then checks whether the previously inactive external device is powered off 512. If it is powered off, then the electronic system 200 returns to block 502. If the previously inactive external electronic device is powered on, the electronic system 200 powers off the electronic device 516.

As described above, in some implementations, electronic system 200 determines whether an active external electronic device remains active. In some implementations, if the active external electronic device does not send a signal for a predetermined time period, then the electronic system 200 treats the electronic device as if it is inactive. In some implementations, the predetermined time period may be 10 seconds, 15 seconds, 30 seconds, 45 seconds, 1 minute, 5 minutes, 15 minutes, 30 minutes, 1 hour, or any other time period. In some implementations, the predetermined time period may be set by the manufacturer of the electronic system 200. In some implementations, the predetermined time period may be set by the user of the electronic system 200. In some implementations, the predetermined time period may be set by the manufacturer and the user. In some implementations, the predetermined time period permits settings on the electronic device 100 to be adjusted or cables connected to the electronic device 100 to be switched from one external electronic device to another external electronic device without the electronic system 200 treating the external electronic device as idle.

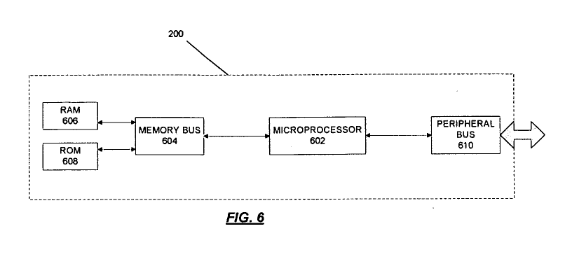

FIG. 6 shows an exemplary implementation of the electronic system 200. The electronic system 200 may include a microprocessor 602, a memory bus 604, random access memory (RAM) 606, read only memory (ROM) 608, and/or a peripheral bus 610. The microprocessor 602 may be a general-purpose digital processor that controls the operation of the electronic system 200. The microprocessor 602 may be a single-chip processor or implemented with multiple components. Using instructions received from memory, the microprocessor 602 may control the reception and manipulation of input data and the output of data.

The memory bus 604 may be utilized by the microprocessor 602 to access RAM 606 and/or ROM 608, depending on whether RAM or ROM, or both, are present. In some implementations, RAM 606 may be used by the microprocessor 602 as a general storage area. In some implementations, RAM 606 may be used as a scratch-pad memory. In some implementations, RAM 606 may be used to store input data and processed data. In some implementations, ROM 608 may be used to store instructions or program code followed by microprocessor 602 as well as other data. The peripheral bus 610 may be used to access the input, output, and storage devices used by the electronic system 600.

In some implementations, the peripheral bus 610 may be used to access a network interface. The network interface may be used to send and receive data over a network. As may be appreciated, the network may be any appropriate network, each electronic system 200 may be connected thereto by way of communication connection(s) in any appropriate manner, and each electronic system 200 may communicate with one or more of the other computing devices in the network in any appropriate manner. As a non-limiting example, the network may be a wired or wireless network within an organization or home or the like, and may include a direct or indirect coupling to an external network such as the Internet or the like.

The microprocessor 602 together with an operating system operates to execute computer code and produce and use data. The computer code and data may reside on RAM 606, ROM 608, or at least one other storage medium. In some implementations, the computer code and data may also reside on a removable program medium and loaded or installed onto the electronic system 200 when needed. Removable program mediums include, but are not limited to, PC-CARD, flash memory, floppy disk, compact disc, DVD, memory stick, external hard drive, or other device capable of serving as a removable program medium.

A number of implementations have been described. Nevertheless, it will be understood that various modifications may be made without departing from the spirit and scope of the disclosures in this application. As a non-limiting example, the electronic system 200 may prompt a user of the electronic system 200 to select whether to change the input source setting when it detects that an external electronic device becomes active. As another non-limiting example, if the electronic system 200 changes from a first active external electronic device to a second external electronic device after the second external electronic device becomes active and the first external electronic device remains active, the electronic system 200 does not change the input source on the electronic device 100 to the first active external electronic device if the first and second active external devices remain active. As another non-limiting example, the electronic system 200 may delay a predetermined time period before switching the input source on the electronic device 100.

In some implementations, the electronic system 200 may delay 5 seconds, 10 seconds, 15 seconds, 30 seconds, 45 seconds, 1 minute, 2 minutes, 3 minutes, 5 minutes, or any other time period before changing the input source on the electronic device 100. Some implementations may permit an external electronic device to be turned on and then turned off within a relatively short time period without the electronic system 200 changing the input source on the electronic device 100. As a non-limiting example, if the electronic device 100 is connected to an inactive DVD player and an active cable box, the input source for the electronic device 100 is set to the active cable box, and the DVD player is powered on so that a DVD can be ejected from the DVD player and then powered off, the electronic system 200 may not change the input source on the electronic device 100 to the DVD player so long as the DVD player is powered off within the predetermined time period.

In some implementations, the electronic system 200 may not change the input source on the electronic device 100 after first detecting that an external electronic device becomes active. In some implementations, the electronic system 200 may change the input source on the electronic device 100 after detecting at least twice that an external electronic device is active. As a non-limiting example, if the electronic device 100 is connected to an inactive DVD player and an active cable box, the input source for the electronic device 100 is set to the active cable box, the electronic system 200 may not change the input source on the electronic device 100 after first detecting that the DVD player is active; instead, the electronic system 200 may change the input source on the electronic device 100 after detecting for a second, third, fourth, fifth, or some other predetermined time that the DVD player is active. Such implementations may permit a user to power on a DVD player, eject a DVD, and then power off the DVD player without the electronic system 200 changing the input source on the electronic device 100.

Additional components may be added to those described above, or components may be removed or rearranged. As a non-limiting example, the electronic system 200 may be electrically connected to or include an infrared (IR) transmitter that is capable of powering off external electronic devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for changing an input source for an electronic device capable of receiving a signal from a plurality of external electronic devices comprising:
an electronic system communicatively coupled to the electronic device and adapted to:
determine if an external electronic device is active;
if an external electronic device is active, determine if an input source for the electronic device is set to the active external electronic device; and
set the input source for the electronic device to the active external electronic device if a change to the input source is required.

2. The system of claim 1, wherein the electronic system is further adapted to monitor the plurality of external electronic devices to determine if a different external electronic device is or becomes active.

3. The system of claim 2, wherein the electronic system is further adapted to set the input source to a different external electronic device if the different external electronic device is or becomes active.

4. The system of claim 3, wherein the electronic system is further adapted to wait a predetermined time period before setting the input source to a different external electronic device to ensure that the different external device remains active.

5. The system of claim 4, wherein the predetermined period comprises at least one of 5 seconds, 10 seconds, 15 seconds, 30 seconds, 45 seconds, 1 minute, 2 minutes, 3 minutes, and 5 minutes.

6. The system of claim 3, wherein the electronic system is further adapted to set the input source to a different external electronic device after detecting at least twice that the different external electronic device is active.

7. The system of claim 1, wherein the electronic system is further adapted to activate a sleep or hibernate mode on the electronic device, if required, after determining that the plurality of external electronic devices is inactive.

8. The system of claim 1, wherein the electronic system is further adapted to power off or activate a sleep or hibernate mode on an external electronic device if the external electronic device is inactive after being active.

9. The system of claim 1, wherein the electronic system is further adapted to power on the electronic device, if required, after determining that one of the plurality of external devices is active.

10. The system of claim 1, wherein the electronic system is further adapted to prompt a user to select whether to change the input setting to the active external electronic device when determining if a change to the input source is required.

11. The system of claim 1, wherein the electronic device comprises a monitor.

12. The system of claim 1, wherein the electronic device comprises a stereo or receiver.

13. A method for changing an input source for an electronic device capable of receiving a signal from a plurality of external electronic devices comprising:
determining if an external electronic device is active;
if an external electronic device is active, determining if an input source for the electronic device is set to the active external electronic device; and
setting the input source for the electronic device to the active external electronic device if a change to the input source is required.

14. The method of claim 13, further comprising monitoring the plurality of external electronic devices to determine if a different external electronic device is or becomes active.

15. The method of claim 14, further comprising setting the input source to a different external electronic device if the different electronic device is or becomes active.

16. The method of claim 15, further comprising waiting a predetermined time period before setting the input source to a different external electronic device to ensure that the different external device remains active.

17. The method of claim 16, wherein the predetermined time period comprises at least one of 5 seconds, 10 seconds, 15 seconds, 30 seconds, 45 seconds, 1 minute, 2 minutes, 3 minutes, and 5 minutes.

18. The method of claim 14, further comprising setting the input source to a different external electronic device after detecting at least twice that the different external electronic device is active.

19. The method of claim 14, further comprising activating a sleep or hibernate mode on the electronic device, if required, after determining that the plurality of external electronic devices is inactive.

20. The method of claim 13, further comprising powering off or activating a sleep or hibernate mode on an external electronic device if the external electronic device is inactive after being active.

21. The method of claim 13, further comprising powering on the electronic device, if required, after determining that one of the plurality of external devices is active.

22. The method of claim 13, further comprising prompting a user to select whether to change the input setting to the active external electronic device when determining if a change to the input source is required.

23. The method of claim 13, wherein the electronic device comprises a monitor.

24. The method of claim 13, wherein the electronic device comprises a stereo or receiver.

25. A system for an electronic device capable of receiving a signal from a plurality of external electronic devices comprising:
an electronic system communicatively coupled to the electronic device and adapted to:
determine if an external electronic device is active;
wake or power on the electronic device, if required, after determining that an external electronic device is active;
if an external electronic device is active, determine if an input source for the electronic device is set to the active external electronic device; and
set the input source for the electronic device to the active external electronic device if a change to the input source is required.

26. The system of claim 25, wherein the electronic system is further adapted to:
monitor the plurality of external electronic devices to determine if a different external electronic device is or becomes active;
set the input source to a different external electronic device if the different electronic device is or becomes active;
activate a sleep or hibernate mode on the electronic device, if required, after determining that the plurality of external electronic devices is inactive; and
power off or activate a sleep or hibernate mode on an external electronic device if the external electronic device is or becomes inactive after being active.

27. The system of claim 25, wherein the electronic device comprises a monitor.

28. The system of claim 25, wherein the electronic device comprises a stereo or receiver.
